(19) United States
(12) Patent Application Publication
(10) Pub. No.: US 2025/0193047 A1
(43) Pub. Date: Jun. 12, 2025

(54) System and Method for Multi-Frequency Band Indoor Channel State Information-Based Physical Layer Authentication

(71) Applicant: Gwangju Institute of Science and Technology, Gwangju (KR)

(72) Inventors: Eui Seok HWANG, Gwangju (KR); Jinho CHOI, Gwangju (KR); Seung Nam HAN, Gwangju (KR); Hae won LEE, Gwangju (KR)

(21) Appl. No.: 18/815,921

(22) Filed: Aug. 27, 2024

(30) Foreign Application Priority Data
Dec. 7, 2023 (KR) 10-2023-0176999

(51) Int. Cl. H04L 25/02; H04W 4/33; H04W 12/06

(52) U.S. Cl. CPC H04L 25/0204; H04W 12/06; H04W 4/33

(57) ABSTRACT

A system for multi-frequency band indoor channel state information-based physical layer authentication comprises a first wireless communication device that is an authentication requesting node and a second wireless communication device that is an authentication verifying node, wherein the first wireless communication device comprises a transmitting unit that sequentially modulates device identification information and a given pilot signal for identifying the first wireless communication device into a plurality of signals based on a plurality of set center frequencies and transmits the plurality of signals, and the second wireless communication device comprises a receiving unit that receives the plurality of signals transmitted from the first wireless communication device and estimates a plurality of channel state information based on the plurality of center frequencies respectively and a physical layer authentication processing unit that determines whether the first wireless communication device is authenticated based on the estimated plurality of channel state information.

### CROSS-REFERENCE TO RELATED APPLICATION

This application claims priority under 35 U.S.C. § 119 to Korean Patent Application No. 10-2023-0176999, filed on Dec. 7, 2023, in the Korean Intellectual Property Office (KIPO), the disclosure of which is incorporated by reference herein in its entirety.

### TECHNICAL FIELD

The present disclosure relates to a physical layer authentication method and system, and more particularly, to a physical layer authentication method and system based on indoor channel state information in multiple frequency bands that increase security stability and reliability using indoor channel state information in multiple frequency bands.

### BACKGROUND

Physical layer authentication is a security technology that utilizes physical characteristics to confirm and authenticate the identity of a user or device in a communication system.

Unlike traditional authentication methods using passwords or codes, physical layer authentication methods mainly identify users by utilizing channel state information based on physical characteristics such as interference, fading, and noise of a communication channel.

Physical layer authentication is mainly used in wireless communication, IoT, and security monitoring systems, and is intended to establish a more secure communication environment in combination with traditional authentication methods.

FIG. 1 schematically illustrates a physical layer authentication system using state information according to the conventional technology.

The authentication requesting nodes B and E send signals X_{B} and X_{E} to the authentication verifying node A to attempt user authentication.

The authentication verifying node A compares the signals X_{B} and X_{E} received from the authentication requesting nodes B and E, respectively, with the registered signal X_{B-R}, compares the respective channel state information h_{AB} and h_{AE} with the registered channel state information h_{AB-R}, and confirms whether the authentication requesting nodes B and E are legitimate users or not.

The authentication verifying node A determines that the received signal X_{B} and the received channel state information h_{AB} coincide with the registered signal X_{B-R} and registered channel state information h_{AE-B}, and allows communication for the corresponding authentication requesting node B. In addition, the authentication verifying node A determines that the received signal X_{E} and received channel state information h_{AE} do not coincide with the registered signal X_{B-R} and registered channel state information h_{AE-B}, and refuses communication for the corresponding authentication requesting node E.

However, in general, since the indoor environment has a monotonous change in a channel compared to the outdoors, a strong association may occur between the illegitimate authentication requesting node E and the legitimate authentication requesting node B according to the location of the illegitimate authentication requesting node E in the room. That is, the illegitimate channel state information h_{AE}, which is channel state information between the illegitimate authentication requesting node E and the legitimate authentication verifying node A, may be formed very similarly to the legitimate channel state information h_{AB}, which is channel state information between the legitimate authentication requesting node B and the authentication verifying node A, according to the location of the illegitimate authentication requesting node E.

FIGS. 2 and 3 illustrate a conventional technology embodiment in which it can be confirmed that the illegitimate authentication requesting node E and the legitimate authentication requesting node B have very similar channel state information at arbitrary locations.

In this embodiment, the signals generated from the legitimate authentication requesting node B and the illegitimate authentication requesting node E were set to a wavelength λ of 2.86 cm, a bandwidth W of 18 MHz, the number of subcarriers in multicarrier transmission N of 36, and a center frequency F of 5.28 GHz. In addition, the illegitimate authentication requesting node E moves in position, and there is a physical distance between the legitimate authentication requesting node B and the illegitimate authentication requesting node E. The physical distance is set within 0 to arbitrary distance D, and the distance D is set to be much larger than ½ of the wavelength λ of the corresponding signal.

FIG. 3 illustrates graphs of the legitimate channel state information h_{AB} and the illegitimate channel state information h_{AE}calculated by the corresponding embodiment. Here, the horizontal axis of the graph is a subcarrier index, and the vertical axis is channel state information.

Referring to FIG. 3, it can be seen that the legitimate channel state information h_{AB} and the illegitimate channel state information h_{AE} are formed to nearly coincide with each other, even though the physical distance is set to be much larger than ½ of the wavelength λ of the signal. When the legitimate channel state information h_{AB} and the illegitimate channel state information h_{AE} coincide, the authentication verifying node A may false-authenticate the illegitimate authentication requesting node Eat the corresponding location as legitimate.

As described above, when the illegitimate authentication requesting node E is located at an arbitrary location and occupies a channel very similar to the legitimate authentication requesting node B, the authentication verifying node A may false-authenticate the illegitimate authentication requesting node E as legitimate and allow communication.

Accordingly, a method for improving the security stability and reliability of the physical layer authentication system 10 according to the conventional technology has been reviewed from various angles.

### SUMMARY

In view of the above, the present disclosure provides a system for multi-frequency band indoor channel state information-based physical layer authentication. The present disclosure has an object to provide a physical layer authentication method and system based on multi-frequency band indoor channel state information, which prevents false authentication due to a strong association between legitimate channel state information and illegitimate channel state information, thereby improving security stability and reliability.

Technical objects to be achieved by the present disclosure are not limited to those described above, and other technical objects not mentioned above may also be clearly understood from the descriptions given below by those skilled in the art to which the present disclosure pertains.

According to the present disclosure, the system for multi-frequency band indoor channel state information-based physical layer authentication may comprise a first wireless communication device that is an authentication requesting node and a second wireless communication device that is an authentication verifying node.

Here, the first wireless communication device may comprise a transmitting unit that sequentially modulates device identification information and a given pilot signal for identifying the first wireless communication device into a plurality of signals based on a plurality of set center frequencies and transmits the plurality of signals.

In addition, the second wireless communication device may comprise: a receiving unit that receives the plurality of signals transmitted from the first wireless communication device and estimates a plurality of channel state information based on the plurality of center frequencies respectively; and a physical layer authentication processing unit that determines whether the first wireless communication device is authenticated based on the estimated plurality of channel state information.

In addition, the transmitting unit may comprise: a data encoding module that converts the device identification information and the pilot signal into M-ary data symbols; a modulation frequency conversion module that sequentially converts a modulation frequency into the plurality of center frequencies; a signal modulation module that sequentially modulates the M-ary data symbols into a plurality of digital waveforms based on the modulation frequency that is sequentially converted into the plurality of center frequencies; and a transmitting module that sequentially transmits the plurality of digital waveform.

In addition, the receiving unit may comprise: a receiving module that sequentially receives the plurality of digital waveforms transmitted from the first wireless communication device; a demodulation frequency conversion module that sequentially converts a demodulation frequency into the plurality of center frequencies; a signal demodulation module that sequentially demodulates the plurality of digital waveforms received by the receiving module into a plurality of M-ary data symbols based on the demodulation frequency that is sequentially converted into the plurality of center frequencies; a channel state information estimation module that estimates modified pilot signals from the demodulated plurality of M-ary data symbols and estimates the plurality of channel state information; and a data decoding module that converts the demodulated plurality of M-ary data symbols and outputs the device identification information.

In addition, the physical layer authentication processing unit may comprise: a device information output module that outputs a plurality of registered channel state information by inputting the device identification information received by the receiving unit; a signal post-processing module that calculates and outputs a test statistic by inputting the plurality of channel state information estimated by the receiving unit and the plurality of registered channel state information; and a legitimacy determination module that determines whether the first wireless communication device is authenticated by inputting the test statistic.

In addition, the second wireless communication device may further comprise a device registration processing unit that registers a given device as a legitimate device and sets a criterion for determining whether to authenticate.

In addition, the device registration processing unit may comprise: a device registration module that stores the device identification information and the estimated plurality of channel state information received by the receiving unit as registered device identification information and a plurality of registered channel state information respectively; a legitimate data group forming module that receives multiple sets of the plurality of signals transmitted from the first wireless communication device and calculates test statistics of the channel state information estimated from each signal to form a legitimate data group; an illegitimate data group forming module that assumes multiple sets of a plurality of illegitimate channel state information based on the plurality of center frequencies and calculates the test statistics of the assumed illegitimate channel state information to form an illegitimate data group; and a hyperplane forming module that forms a hyperplane of at least one test statistic using the test statistics of the legitimate data group and the test statistics of the illegitimate data group based on the plurality of center frequencies.

In addition, the test statistics may be calculated as Euclidean distances of each channel state information.

In addition, the legitimacy determination module may determine whether the test statistics of the estimated plurality of channel state information are legitimate or illegitimate by applying the test statistics of the estimated plurality of channel state information calculated through the signal post-processing module to the hyperplane formed by the hyperplane forming module, and determine that the legitimacy of the first wireless communication device is authenticated when all the test statistics of the estimated plurality of channel state information are determined to be legitimate.

In addition, the second wireless communication device may further comprise a transmitting unit that transmits an authentication confirmation signal to the first wireless communication device when the first wireless communication device is authenticated as legitimate.

In addition, the first wireless communication device and the second wireless communication device may be both authentication verifying nodes and authentication requesting nodes, and the second wireless communication device may further comprise a transmitting unit that sequentially modulates device identification information and the given pilot signal for identifying the second wireless communication device into a plurality of signals based on the plurality of center frequencies and transmits them to the first wireless communication device, and the estimated plurality of channel state information may be a plurality of forward direction channel state information.

In addition, the first wireless communication device may comprise: a receiving unit that receives a plurality of signals transmitted from the second wireless communication device and estimates a channel state information—a plurality of reverse direction channel state information—in which the plurality of signals from the second wireless communication device are transmitted, respectively; and a physical layer authentication processing unit that determines whether to authenticate the second wireless communication device based on the plurality of reverse direction channel state information.

According to another embodiment of the present disclosure, the method for multi-frequency band indoor channel state information-based physical layer authentication, may comprise: requesting an authentication, which sequentially modulates device identification information and the given pilot signal for identifying a first wireless communication device into a plurality of signals based on a plurality of set center frequencies and transmitting the plurality of signals at the first wireless communication device; accepting an authentication request, which receives the plurality of signals transmitted from the first wireless communication device by the requesting the authentication, estimates a plurality of channel state information, and calculates the device identification information in a second wireless communication device; and processing a physical layer authentication, which determines whether the first wireless communication device is authenticated based on the estimated plurality of channel state information at the second wireless communication device.

In addition, the accepting the authentication request may comprises estimating the channel state information, which estimates the plurality of channel state information from the plurality of signals received by the accepting the authentication request based on the plurality of center frequencies.

In addition, the requesting the authentication may comprise: encoding authentication data, which converts the device identification information and the pilot signal into M-ary data symbols; converting a modulation frequency which sequentially converts the modulation frequency into the plurality of center frequencies; modulating the authentication data, which sequentially modulates the M-ary data symbol into a plurality of digital waveforms based on the modulation frequency sequentially converted into the plurality of center frequencies; and a transmitting the authentication data, which sequentially transmitting the plurality of digital waveforms.

In addition, the accepting the authentication request may comprise: receiving the authentication data, which sequentially receives the plurality of digital waveforms of the first wireless communication device transmitted by the transmitting the authentication data; converting a demodulation frequency, which sequentially converts the demodulation frequency into the plurality of center frequencies; demodulating the authentication data, which sequentially demodulates the plurality of digital waveforms received by the receiving the authentication data to a plurality of M-ary data symbols based on the demodulation frequency sequentially converted into the plurality of center frequencies; decoding the authentication data, which converts the demodulated plurality of M-ary data symbols and outputs the device identification information.

In addition, in the estimating the channel state information, the plurality of channel state information is estimated by estimating modified pilot signals from the demodulated plurality of M-ary data symbols respectively.

In addition, the processing the physical layer authentication may comprise: outputting device information, which outputs a plurality of registered channel state information by inputting the device identification information outputted by the accepting the authentication; post-processing the authentication data, which calculates and outputs a test statistic by inputting the estimated plurality of channel state information estimated through the channel state information estimating step and the plurality of registered channel state information; determining legitimacy, which determines whether the first wireless communication device is authenticated by inputting the test statistic.

In addition, the method may further comprise processing a device registration, which registers a given device as a legitimate device, and sets a criterion for determining whether to authenticate, at the second wireless communication device.

In addition, wherein the processing a device registration may comprise: requesting a registration, which sequentially modulates the device identification information and the pilot signal into the plurality of signals based on the plurality of center frequencies, and transmits the plurality of signals, at the first wireless communication device; accepting a registration request, which receives the plurality of signals transmitted from the first wireless communication device by the requesting the registration, estimates the plurality of channel state information, and calculates device identification information at the second wireless communication device; and storing registration information, which stores the device identification information of the first wireless communication device as registered device identification information and stores the estimated plurality of channel state information as the plurality of registered channel state information at the second wireless communication device.

In addition, the accepting the registration request comprise estimating the channel state information, which estimates the plurality of channel state information from the plurality of signals received by the accepting the registration request based on the plurality of center frequencies, respectively.

In addition, the requesting the registration may comprise: encoding registration data, which converts the device identification information and the pilot signal into M-ary data symbols; converting a modulation frequency, which sequentially converts the modulation frequency into the plurality of center frequencies; modulating the registration data, which sequentially modulates the M-ary data symbols into a plurality of digital waveforms based on the modulation frequency sequentially converted into the plurality of center frequencies; and transmitting the registration data, which sequentially transmits the plurality of digital waveforms.

In addition, the accepting the registration request may comprise: receiving the registration data, which sequentially receives the plurality of digital waveforms of the first wireless communication device transmitted by the transmitting the registration data; a converting a demodulation frequency, which sequentially converts the demodulation frequency into the plurality of center frequencies; demodulating the registration data, which sequentially demodulates the plurality of digital waveforms received by the receiving the registration data to a plurality of M-ary data symbols based on the demodulation frequency sequentially converted into the plurality of center frequencies; and decoding the registration data, which converts the demodulated plurality of M-ary data symbols and outputting the device identification information,

In addition, in the estimating the channel state information in the accepting a registration request, the plurality of channel state information is estimated by estimating modified pilot signals from the demodulated plurality of M-ary data symbols, respectively.

In addition, the processing a device registration may comprise forming an authentication criterion which sets the criterion for determining whether to authenticate the first wireless communication device.

In addition, the forming the authentication criterion may comprise forming a legitimate data group, which collects multiple sets of the plurality of channel state information transmitted from the first wireless communication device to the second wireless communication device based on the plurality of center frequencies, and calculates test statistics respectively to form the legitimate data group; forming an illegitimate data group, which assumes multiple sets of a plurality of illegitimate channel state information based on the plurality of center frequencies and calculates the test statistics of the assumed illegitimate channel state information respectively to form the illegitimate data group, and forming a hyperplane, which forms a hyperplane of at least one test statistic using the test statistics of the legitimate data group and the test statistics of the illegitimate data group based on the plurality of center frequencies.

In addition, the forming the legitimate data group may comprise: transmitting the authentication criterion, which modulates the device identification information and the pilot signal sequentially into the plurality of signals based on the plurality of center frequencies, and transmits the plurality of signals at the first wireless communication device; receiving the authentication criterion, which receives the plurality of signals transmitted from the first wireless communication device by the transmitting the authentication criterion, at the second wireless communication device; and estimating the channel state information which estimates the plurality of channel state information from the plurality of signals received by the receiving the authentication criterion based on the plurality of center frequencies at the second wireless communication device.

In addition, the multiple sets of the plurality of channel state information may be collected by repeatedly performing the transmitting the authentication criterion, the receiving the authentication criterion, and the estimating the channel state information in the forming the legitimate data group.

In addition, the test statistics may be calculated as Euclidean distances of each channel state information.

In addition, in the determining legitimacy, legitimacy or illegitimacy is determined by applying the test statistics of the channel state information calculated by the post-processing the authentication data to the hyperplane of the test statistics, and authentication of legitimacy of the first wireless communication device is determined when all the test statistics of the estimated plurality of channel state information are determined to be legitimate.

In addition, the first wireless communication device and the second wireless communication device may be both authentication verifying nodes and authentication requesting nodes, the estimated plurality of channel state information may be a plurality of forward direction channel state information, the requesting the authentication may be requesting a forward direction authentication, the accepting the authentication request may be accepting a forward direction authentication request, the estimating the channel state information may be estimating a forward direction channel state information, the processing the physical layer authentication may be processing a forward direction physical layer authentication.

In addition, the method may comprise: requesting a reverse direction authentication, which sequentially modulates the device identification information and the given pilot signal for identifying the second wireless device into a plurality of signals based on the plurality of center frequencies at the second wireless communication device; accepting a reverse direction authentication request, which receives the plurality of signals transmitted from the second wireless communication device by the accepting a reverse direction authentication request, at the first wireless communication device; estimating reverse direction channel state information, which estimates a plurality of reverse direction channel state information from the plurality of signals received by the accepting a reverse direction authentication request based on the plurality of center frequencies at the first wireless communication device; and processing a reverse direction physical layer authentication, which determines whether the second wireless communication device is authenticated based on the estimated plurality of reverse direction channel state information at the second wireless communication device.

In addition, the method may further comprise notifying the authentication, which transmits an authentication completion signal to the first wireless communication device when the first wireless communication device is authenticated as legitimate, at the second wireless communication device.

### Advantageous Effects

According to the present disclosure, in a system and a method for multi-frequency band indoor channel state information-based physical layer authentication, by improving the conventional technology to perform physical layer authentication based on multi-frequency band indoor channel state information, it is possible to prevent false authentication due to a strong association between channel state information of a legitimate authentication requesting node and channel state information of an illegitimate authentication requesting node in an indoor environment and to improve security stability and reliability.

The effects of the present disclosure are not limited to the above-mentioned effects, and other effects that are not mentioned can be clearly understood by those skilled in the art from the description of the claims.

### BRIEF DESCRIPTION OF THE DRAWINGS

FIG. 1 is a diagram schematically illustrating the physical layer authentication system using state information according to the conventional technology.

FIG. 2 is a diagram illustrating an embodiment of a physical layer authentication system according to the conventional technology.

FIG. 3 is a channel state information graph derived through an experimental example of a physical layer authentication system using state information according to the conventional technology.

FIG. 4 is a schematic block diagram of the system for multi-frequency band indoor channel state information-based physical layer authentication according to a first embodiment of the present disclosure.

FIG. 5 is a block diagram of a transmitting unit of a first wireless communication device according to an embodiment of the present disclosure.

FIG. 6 is a block diagram of a receiving unit of a second wireless communication device according to an embodiment of the present disclosure.

FIG. 7 is a block diagram of a device registration processing unit of a second wireless communication device according to an embodiment of the present disclosure.

FIG. 8 is a block diagram of a physical layer authentication processing unit of a second wireless communication device according to an embodiment of the present disclosure.

FIG. 9 is a schematic block diagram of the system for multi-frequency band indoor channel state information-based physical layer authentication according to a second embodiment of the present disclosure.

FIG. 10 is a diagram illustrating an embodiment of the system for multi-frequency band indoor channel state information-based physical layer authentication according to a first experimental example of the present disclosure.

FIG. 11 is a graph illustrating an experimental result of the first experimental example of the present disclosure.

FIG. 12 is a diagram illustrating an embodiment of the system for multi-frequency band indoor channel state information-based physical layer authentication according to a second experimental example of the present disclosure.

FIGS. 13A, 13B, and 13C show a hyperplane of the test statistics using the Euclidean distance of channel state information in two multi-frequency bands as the test statistics.

FIG. 14 is a diagram illustrating a probability of false detection and a probability of non-detection of an illegitimate authentication requesting node.

FIG. 15 is a flowchart illustrating a device registration processing step of the method for multi-frequency band indoor channel state information-based physical layer authentication according to the present disclosure.

FIG. 16 is a flowchart illustrating a device authentication processing step of the method for multi-frequency band indoor channel state information-based physical layer authentication according to the present disclosure.

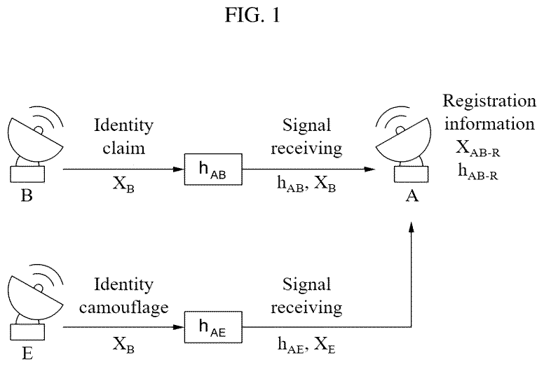

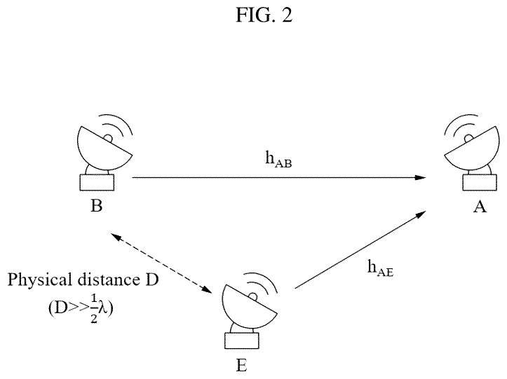

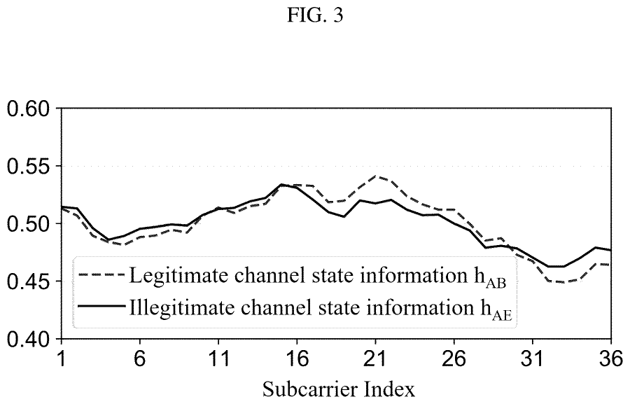

### DETAILED DESCRIPTION

Hereinafter, specific details for the implementation of the present disclosure will be described in detail with reference to the accompanying drawings. However, in the following description, if there is a risk of unnecessarily obscuring the gist of the present disclosure, a detailed description of well-known functions or configurations will be omitted.

In the accompanying drawings, the same or corresponding components are given the same reference numerals. In addition, in the following descriptions of the embodiments, duplicate descriptions of the same or corresponding components may be omitted. However, even if the description of a component is omitted, it is not intended that such a component is not included in any embodiment.

The advantages and features of the embodiments disclosed herein, and the methods of achieving them, will become apparent by reference to the embodiments described below with the accompanying drawings. However, the present disclosure is not limited to the embodiments disclosed below, but may be implemented in various forms different from each other, and the present embodiments are provided to completely inform ordinary skills of the present disclosure.

Unless otherwise defined, all terms (including technical and scientific terms) used herein may be used in a meaning that can be commonly understood by those skilled in the art to which this invention pertains. In addition, terms defined in commonly used dictionaries are not interpreted ideally or excessively unless specifically defined.

For example, the term “technique” may refer to a system, a method, a computer readable instruction, a module, an algorithm, a hardware logic, and/or operations throughout the document and allowed by the context described above.

The terms used in this specification will be briefly described, and the disclosed embodiment will be described in detail. The terms used in this specification have been selected to be interpreted as widely as possible while considering the functions in the present disclosure, but this may vary depending on the intention, precedent, or the emergence of new technology by those skilled in the related field. In addition, in certain cases, there are also terms arbitrarily selected by the applicant, and in this case, the meaning will be described in detail in the relevant description of the invention. Therefore, the terms used in the present disclosure should be defined based on the meaning of the term and the overall content of the present disclosure, rather than the simple name of the term.

The expressions of a singular component in this specification include plural expressions unless the context clearly specifies it to be a singular component. In addition, the plural expressions include a singular expression unless the context clearly specifies that they are plural. When it is said that a part in the entire specification includes a component, this means that it may further include other components, rather than excluding other components unless otherwise specified.

In the present disclosure, the terms “include” and “including” and “comprise” and “comprising” may indicate that features, steps, operations, elements, and/or components exist, but do not exclude the addition of one or more other functions, steps, operations, elements, components, and/or combinations thereof.

In the present disclosure, when a specific component is referred to as being “coupled,” “combined,” “connected,” “associated,” or “reacted” to or with any other component, the specific component may be directly coupled, combined, connected, associated, or reacted to or with another component, but is not limited thereto. For example, one or more intermediate components may be present between the specific component and the other component. In addition, in the present disclosure, “and/or” may include each of the one or more listed items or a combination of at least a portion of the one or more items.

In the present disclosure, the terms “first,” “second,” and the like are used to distinguish a specific component from other components, and the above-described components are not limited by these terms. For example, the “first” component may be used to refer to elements of the same or similar form as the “second” component.

In the present specification, the “portion” or “module” includes a unit implemented by hardware or software, and a unit implemented by both hardware and two or more units may be implemented by hardware.

The system described below constitutes one embodiment and does not intend to limit the claims to any one specific operating environment. The present disclosure may be used in other environments without departing from the technical spirit and scope of the claimed subject matter.

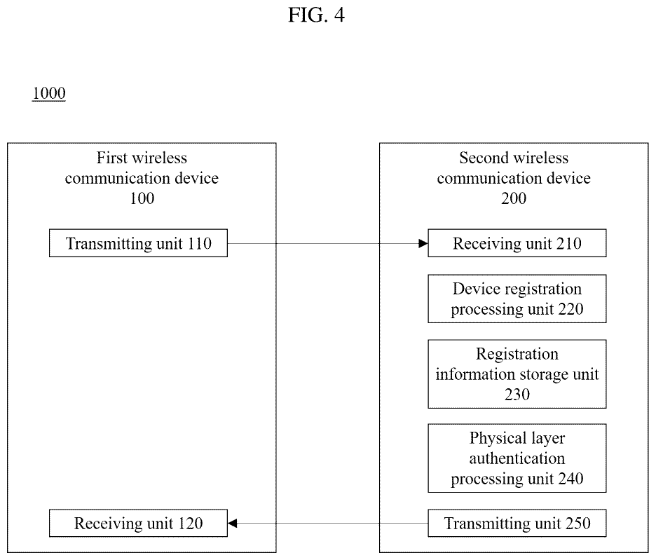

FIG. 4 is a schematic block diagram of a system 1000, the system for multi-frequency band indoor channel state information-based physical layer authentication, according to a first embodiment of the present disclosure.

Referring to FIG. 4, the system 1000, which is a system for multi-frequency band indoor channel state information-based physical layer authentication according to the first embodiment of the present disclosure, may be a unidirectional authentication system including a first wireless communication device 100 that is an authentication requesting node and a second wireless communication device 200 that is an authentication verifying node.

The first wireless communication device 100 includes a transmitting unit 110 that sequentially modulates data including device identification information ID and a given pilot signal for identifying the first wireless communication device into a plurality of signals based on a plurality of center frequencies F1, F2, F3 set, and then sequentially transmits them to the second wireless communication device 200.

The second wireless communication device 200 includes a receiving unit 210 that receives the plurality of signals transmitted from the first wireless communication device 100 and estimates a plurality of channel state information H1, H2, H3 based on the plurality of center frequencies (F1, F2, F3 from the received plurality of signals.

In addition, the second wireless communication device 200 includes a device registration processing unit 220 that registers given devices as legitimate devices and sets a criterion for determining whether to authenticate, and a registration information storage unit 230 that stores registered device identification information ID_{_R} and a plurality of registered channel state information H1_{_R}, H2_{_R}, H3_{_R}.

In addition, the second wireless communication device 200 includes a physical layer authentication processing unit 240 that determines whether to authenticate the first wireless communication device 100 based on the plurality of channel state information H1, H2, H3 estimated by the receiving unit 210.

In addition, the second wireless communication device 200 may further include a transmitting unit 250 that transmits an authentication confirmation signal to the first wireless communication device 100 when the first wireless communication device 100 is authenticated by the physical layer authentication processing unit 240.

In addition, the first wireless communication device 100 may further include a receiver 120 that receives the authentication confirmation signal from the transmitting unit 250.

The pilot signal may be a signal defined in arbitrary wireless communication standard. Each pilot signal is defined in wireless communication standards such as Wi-Fi, LTE, and 5G, and these pilot signals are mainly used to estimate channel state information or measure signal strength and interference in various wireless communication scenarios.

In addition, according to the present disclosure, one given pilot signal or a plurality of given pilot signals for identifying the first wireless communication device may be set. Hereinafter, the present disclosure will describe embodiments assuming a case where one pilot signal is set, however, the present disclosure also includes a case where a plurality of pilot signals are set.

The center frequency F1, F2, F3 may be the geometric mean of the highest frequency and the lowest frequency of a given frequency band.

According to the present disclosure, multiple frequency bands based on a plurality of center frequencies F1, F2, F3 are set in the first wireless communication device 100 and the second wireless communication device 200, and a plurality of signals based on the multiple frequency bands are sequentially transmitted from the first wireless communication device 100 to the second wireless communication device 200.

Here, the second wireless communication device 200 estimates the plurality of channel state information H1, H2, H3 through the plurality of signals received in the multiple frequency bands, and performs device registration and physical layer authentication based on the estimated channel state information.

In addition, the plurality of signals modulated and output through the transmitting unit 110 may be digital waveforms S1, S2, S3. Hereinafter, the present disclosure will be described assuming that a plurality of signals modulated and output through the transmitting unit 110 are digital waveforms. However, the plurality of signals are not limited to digital waveforms and various signal formats may be applied, for example, the plurality of signals may be modulated into an analog waveform.

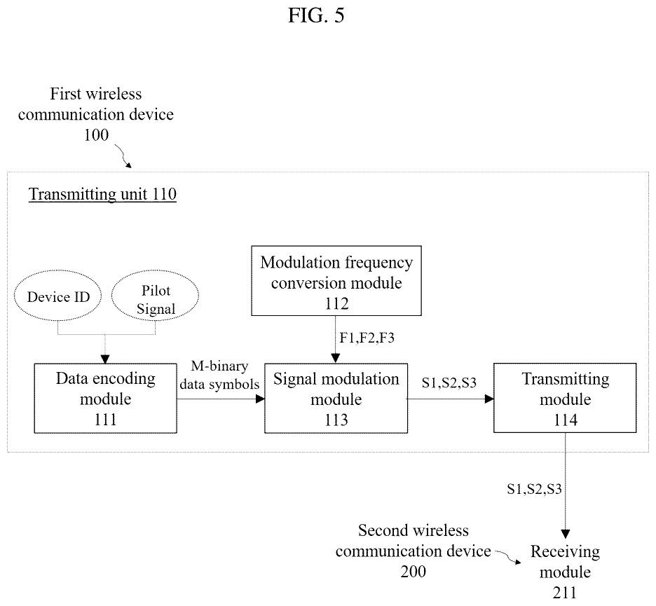

In FIG. 5, a block diagram of the transmitting unit 110 of the first wireless communication device 100 is illustrated.

The transmitting unit 110 of the first wireless communication device 100 includes a data encoding module 111, a modulation frequency conversion module 112, a signal modulation module 113, and a transmitting module 114.

The data encoding module 111 performs encoding to convert data including the device identification information and the pilot signal of the first wireless communication device 100 into M-ary data symbols. Here, the encoding rule for converting data into M-ary data symbols may be generally published rules, for example, rules included in each wireless communication standard. In addition, M may be an integer of 2 or more.

The modulation frequency conversion module 112 sequentially converts a modulation frequency applied to the signal modulation module 113 into a plurality of set center frequencies F1, F2, F3. Here, the conversion order of the plurality of center frequencies F1, F2, F3 set may be randomly designated or may be randomly set.

The signal modulation module 113 modulates the M-ary data symbols output from the data encoding module 111 to digital waveforms S1, S2, S3 based on the set modulation frequency.

Here, since the modulation frequency is sequentially converted into a plurality of center frequencies F1, F2, F3 by the modulation frequency conversion module 112, the M-ary data symbols output from the encoding module 111 are sequentially modulated into a plurality of digital waveforms S1, S2, S3 based on the plurality of center frequencies F1, F2, F3, respectively.

The transmitting module 114 transmits the plurality of digital waveforms S1, S2, S3 output from the signal modulation module 113 to the second wireless communication device 200.

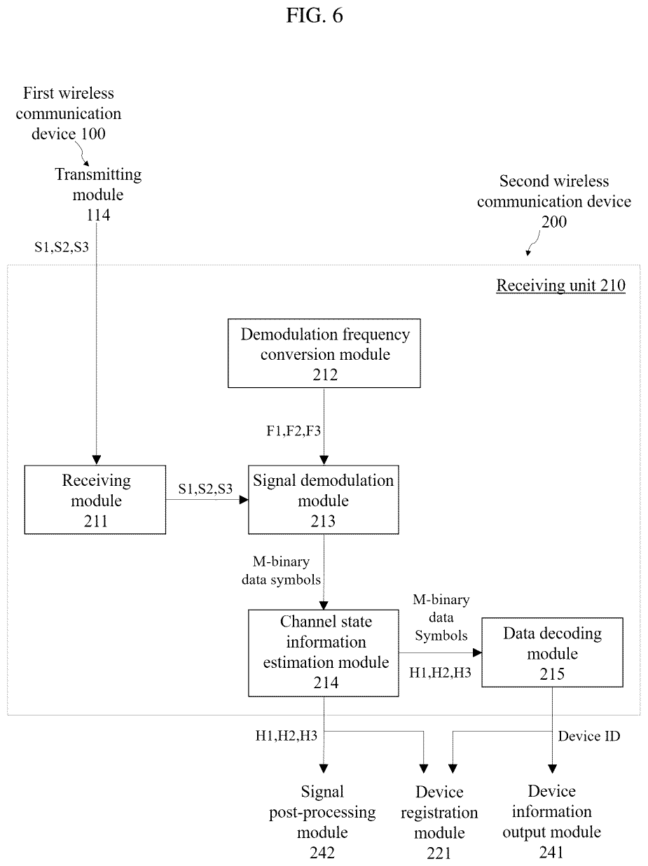

In FIG. 6, a block diagram of the receiving unit 210 of the second wireless communication device 200 is illustrated.

The receiving unit 210 of the second wireless communication device 200 includes a receiving module 211, a demodulation frequency conversion module 212, a signal demodulation module 213, a channel state information estimation module 214, and a data decoding module 215.

The receiving module 211 sequentially receives a plurality of digital waveforms S1, S2, S3 sequentially transmitted from the first wireless communication device 100.

The demodulation frequency conversion module 212 sequentially converts a demodulation frequency applied to the signal demodulation module 213 into the set plurality of center frequencies F1, F2, F3. Here, the order in which the modulation frequency conversion module 112 converts the modulation frequency into the plurality of center frequencies F1, F2, F3 and the order in which the demodulation frequency conversion module 212 converts a demodulation frequency into the plurality of center frequencies F1, F2, F3 may be set the same. In addition, the digital waveform S1, S2, S3 may include a conversion order information of the plurality of center frequencies F1, F2, F3, and the demodulation frequency conversion module 212 may convert the plurality of center frequencies F1, F2, F3 according to the corresponding conversion order information to have the same conversion order as the modulation frequency conversion module 112.

In addition, the number of center frequencies set in the first wireless communication device 100 and the number of center frequencies set in the second wireless communication device 200 may be set to be the same. In addition, the number of subcarriers in multicarrier transmission N can be set equally as well.

The number of center frequencies and the number of subcarriers in multicarrier transmission N may be preset input to the first wireless communication device 100 and the second wireless communication device 200, respectively, or may be set to agree by communicating with the first wireless communication device 100 and the second wireless communication device 200. The signal demodulation module 213 demodulates the plurality of digital waveforms S1, S2, S3 received through the receiving module 211 to M-ary data symbols based on the set modulation frequency.

Here, since the demodulation frequency is sequentially converted into a plurality of center frequencies F1, F2, F3 by the demodulation frequency conversion module 212, the plurality of digital waveform S1, S2, S3 received through the receiving module 211 are sequentially demodulated into a plurality of M-ary data symbols based on the plurality of center frequencies F1, F2, F3, respectively.

The channel state information estimation module 214 estimates modified pilot signals from the plurality of M-ary data symbols demodulated through the signal demodulation module 213, and estimates the plurality of channel state information H1, H2, H3 for the plurality of channels that the plurality of digital waveform S1, S2, S3 are transmitted from the estimated modified pilot signals. The plurality of estimated channel state information H1, H2, H3 may be transmitted to a signal post-processing module 242 and a device registration module 221, which are described later.

The data decoding module 215 performs decoding that converts the demodulated plurality of M-ary data symbols and outputs device identification information ID. Here, the decoding process may be performed based on the plurality of channel state information H1, H2, H3 output through the channel state information estimation module 214. The outputted device identification information ID may be transmitted to the device registration module 221 and a device information output module 241, which are described later.

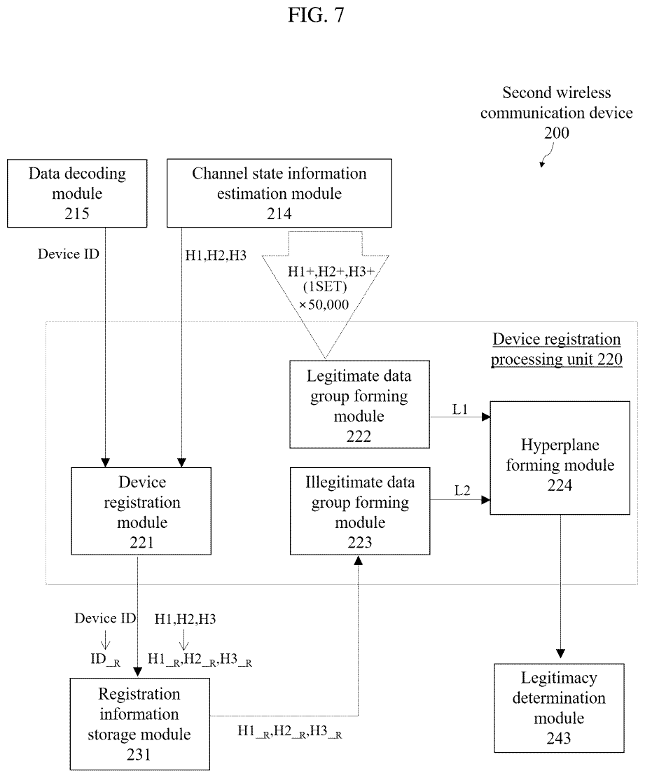

In FIG. 7, a block diagram of the device registration processing unit 220 of the second wireless communication device 200 is illustrated.

The device registration processing unit 220 of the second wireless communication device 200 includes a device registration module 221, a legitimate data group forming module 222, an illegitimate data group forming module 223, and a hyperplane forming module 224.

The device registration module 221 stores the device identification information ID of a given wireless communication device and the plurality of channel state information H1, H2, H3 corresponding to the corresponding device identification information ID in a registration information storage module 231 of the registration information storage unit 230, and registers the corresponding wireless communication device as a legitimate device.

Here, the device identification information ID_{_R} of the wireless communication device may be stored in the registration information storage module 231 as registration device identification information, and the plurality of channel state information H1, H2, H3 corresponding to the corresponding device identification information ID may be stored in the registration information storage module 231 as a plurality of registered channel state information H1_{_R},H2_{_R},H3_{_R}.

In addition, the device identification information ID of the wireless communication device and the plurality of channel state information H1, H2, H3 corresponding to the device identification information ID of the wireless communication device may be output from the receiving unit 210 of the second wireless communication device 200. That is, the device identification information ID stored as the registration device identification information ID_{_R} may be output through the data decoding module 215 of the receiving unit 210 of the second wireless communication device 200. In addition, the plurality of channel state information (H1, H2, H3) stored in the plurality of registered channel state information H1_{_R}, H2_{_R}, H3_{_R} may be the plurality of channel state information H1, H2, H3 estimated through the channel state information estimation module 214 of the receiving unit 210 of the second wireless communication device 200.

In addition, the given wireless communication device registered as a legitimate device in the second wireless communication device 200 through the device registration module 221 may be the first wireless communication device 100.

The legitimate data group forming module 222 receives multiple sets of the plurality of digital waveforms transmitted from the first wireless communication device 100, calculates the test statistics of legitimate channel state information H1+, H2+, H3+ estimated from each of the digital waveforms, and forms the legitimate data group L1 made up of the test statistics of the legitimate channel state information. Here, the legitimate data group forming module 222 may perform the above processes when the first wireless communication device 100 is registered through the device registration module 221.

Here, the calculation of the test statistics is a concept that includes a series of signal processing processes such as main component analysis, signal normalization, and geometric distance calculation. In addition, Euclidean distance of each channel state information may be used as the test statistics, and various types of test statistics may be applied, without being limited thereto.

In addition, the legitimate channel state information H1+, H2+, H3+ is the channel state information of a communication channel formed between the first wireless communication device 100 registered as a legitimate connection target and the second wireless communication device 200. That is, the legitimate channel state information H1+, H2+, H3+ is the channel state information estimated from the plurality of digital waveforms transmitted from the first wireless communication device 100.

In addition, 1 set of digital waveforms is the plurality of digital waveforms received from the first wireless communication device 100 based on the plurality of center frequencies F1, F2, F3. And, 1 set of legitimate channel state information H1+, H2+, H3+, based on the plurality of center frequencies F1, F2, F3, may be estimated from the 1 set of digital waveforms through the channel state information estimation module 214.

In addition, the channel state information between the first wireless communication device 100 and the second wireless communication device 200 is based on the plurality of center frequencies F1, F2, F3, and the number of the sets of the legitimate channel state information may be sufficiently large enough to have a statistical meaning. For example, as shown in FIG. 7, when the number of the sets of the plurality of digital waveforms is set to 50000 and the three center frequencies F1, F2, F3 are set, 50000 digital waveforms are received per each center frequency F1, F2, F3 from the first wireless communication device 100, and a total of 150000 digital waveforms are received. In addition, 50000 legitimate channel state information per each center frequency F1, F2, F3 is estimated through each digital waveform, and a total of 150000 legitimate channel state information are estimated. That is, as shown in FIG. 7, 50000 of set of legitimate channel state information H1+, H2+, H3+ may be estimated through the channel state information estimation module 214 and transmitted to the legitimate data group forming module 222.

The illegitimate data group forming module 223 assumes multiple set of a plurality of illegitimate channel state information based on the plurality of center frequencies F1, F2, F3 set in the first wireless communication device 100 and the second wireless communication device 200, and calculates the test statistics of the illegitimate channel state information, and forms the illegitimate data group L2 made up of the test statistics of the illegitimate channel state information. Here, the illegitimate data group forming module 223 may perform the above processes when the first wireless communication device 100 is registered through the device registration module 221.

Here, the illegitimate channel state information may be arbitrarily calculated channel state information of the communication channel between the corresponding illegitimate wireless communication device and the second wireless communication device 200, by assuming that other illegitimate wireless communication devices existed around the first wireless communication device 100 registered as a legitimate connection target.

In addition, the negative channel state information may be calculated based on the registered channel state information H1_{_R}, H2_{_R}, H3_{_R} of the first wireless communication device 100 registered as a legitimate connection target, as shown in FIG. 7.

In addition, at least one illegitimate wireless communication device may be arbitrarily installed around the first wireless communication device 100 registered as a legitimate connection target, the illegitimate data group forming module 223 may form the illegitimate data group L2 by estimating the illegitimate channel state information from the corresponding illegitimate wireless communication device.

In addition, the illegitimate channel state information may be sufficiently large enough to have a statistical meaning. For example, it may be set to 50000 of the illegitimate channel state information. In this case, 50000 digital waveforms per center frequency F1, F2, F3 are received from the first wireless communication device 100, and 50000 channel state information is collected per center frequency F1, F2, F3.

The hyperplane forming module 224 forms the hyperplane of at least one test statistic using the test statistics of the legitimate data group L1 output from the legitimate data group forming module 222 and the test statistics of the illegitimate data group L2 output from the illegitimate data group forming module 223. The hyperplane formed through the hyperplane forming module 224 may be provided to a legitimacy determination module 243 which is described later to authenticate a given device.

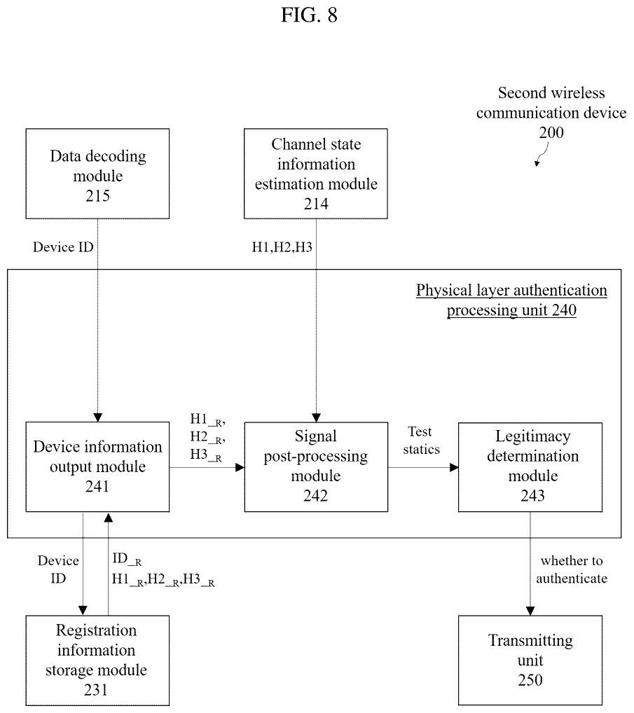

In FIG. 8, a block diagram of the physical layer authentication processing unit 240 of the second wireless communication device 200 is illustrated.

The physical layer authentication processing unit 240 of the second wireless communication device 200 includes a device information output module 241, a signal post-processing module 242, and the legitimacy determination module 243.

The device information output module 241 outputs the plurality of registered channel state information H1_{_R}, H2_{_R}, H3_{_R} by inputting the device identification information received through the data decoding module 215 of the receiving unit 210. Here, the plurality of registered channel state information corresponds to the device identification information received through the receiving unit.

The device information output module 241 searches the registration information storage module 231, and if there is the same registration device identification information ID as the device identification information ID received through the receiving unit 210, it may read and output the plurality of registered channel state information H1_{_R}, H2_{_R}, H3_{_R} corresponding to the corresponding registered device identification information ID.

The signal post-processing module 242 calculates and outputs the test statistics of the plurality of channel state information H1, H2, H3 estimated through the channel state information estimation module 214 of the receiving unit 210. Here, the calculating and the outputting of the signal post-processing module 242 is performed by inputting the plurality of channel state information H1, H2, H3 estimated through the channel state information estimation module 214 of the receiving unit 210 and the plurality of registered channel state information H1_{_R}, H2_{_R}, H3_{_R}.

The legitimacy determination module 243 is a module that outputs a hypothesis result in a true or false form by inputting the test statistics output from the signal post-processing module 242 and determines whether to authenticate the first wireless communication device.

The legitimacy determination module 243 may include a comparator, a linear classifier including support vector machine, a kernel-based nonlinear classifier, and the like for hypothesis verification.

The legitimacy determination module 243 applies the test statistics output through the signal post-processing module 242 to the hyperplane of the test statistics output through the hyperplane forming module 224, and determines the legitimates or illegitimates of the plurality of channel state information H1, H2, H3 estimated through the receiving unit 210.

Here, in the hyperplane of the test statistics output through the hyperplane forming module 224, when the test statistics of the plurality of channel state information H1, H2, and H3 estimated through the receiving unit 210 are determined to be legitimate, the plurality of channel state information H1, H2, H3 estimated through the receiving unit 210 may be determined to be legitimate.

In addition, when it is determined that all the plurality of channel state information H1, H2, H3 estimated through the receiving unit 210 are legitimate, the legitimacy determination module 243 determines that the legitimate of the first wireless communication device 100 is authenticated.

In addition, when the first wireless communication device 100 is authenticated as legitimate from the legitimacy determination module 243 of the physical layer authentication processing unit 240, the second wireless communication device 200 may transmit an authentication confirmation signal to the first wireless communication device 100 through the transmitting unit 250. Here, the legitimacy determination module 243 may transmit a signal of whether to authenticate to the transmitting unit 250.

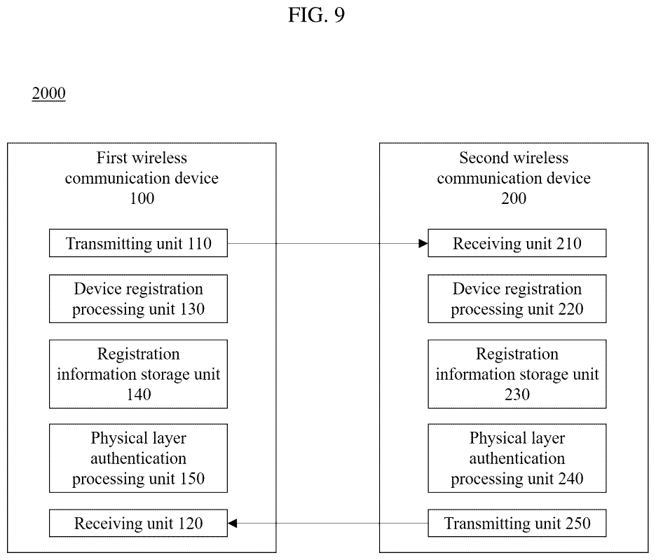

FIG. 9 is a schematic block diagram of a system 2000, the system for multi-frequency band indoor channel state information-based physical layer authentication, according to a second embodiment of the present disclosure.

Referring to FIG. 9, the system 2000, which is the system for multi-frequency band indoor channel state information-based physical layer authentication according to the second embodiment of the present disclosure, includes a first wireless communication device 100 and a second wireless communication device 200 that are both authentication verifying nodes and authentication requesting nodes.

The system 2000, which is the system for multi-frequency band indoor channel state information-based physical layer authentication according to the second embodiment of the present disclosure, follows the system 1000, which is the system for multi-frequency band indoor channel state information-based physical layer authentication according to the first embodiment of the present disclosure. However, the system 2000 according to the second embodiment of the present disclosure is different from the first embodiment in that the receiving unit 120, the device registration processing unit 130, the registration information storage unit 140, and the physical layer authentication processing unit 150 are further included in the first wireless communication device 100.

Here, the receiving unit 120, the device registration processing unit 130, the registration information storage unit 140, and the physical layer authentication processing unit 150 of the first wireless communication device 100 may include the same configuration as the receiving unit 210, the device registration processing unit 220, the registration information storage unit 230, and the physical layer authentication processing unit 240 of the second wireless communication device 200.

In addition, the transmitting unit 110 of the first wireless communication device 100 may include the same configuration as the transmitting unit 250 of the second wireless communication device 200.

In addition, the system 2000, which is the system for multi-frequency band indoor channel state information-based physical layer authentication according to the second embodiment of the present disclosure, is different from the first embodiment in that the same configuration as the transmitting unit 110 of the first wireless communication device 100 is included in the transmitting unit 250 of the second wireless communication device 200.

According to the second embodiment, a plurality of signals based on a plurality of frequency bands may be sequentially transmitted from the second wireless communication device 200 to the first wireless communication device 100. In addition, the first wireless communication device 100 may estimate the plurality of channel state information H1, H2, H3 through the plurality of signals received in the plurality of frequency bands, and may perform device registration and physical layer authentication for the second wireless communication device 200 based on the estimated channel state information H1, H2, H3.

That is, the second embodiment includes all the contents of the first embodiment, and the contents of changing the roles of the first wireless communication device 100 and the second wireless communication device 200 in the first embodiment may be further included.

That is, according to the second embodiment, the system 2000 may be a bidirectional authentication system that registration and authentication are performed between the first wireless communication device 100 and the second wireless communication device 200.

In addition, the plurality of channel state information H1, H2, H3 estimated by the plurality of digital waveforms S1, S2, S3 transmitted from the first wireless communication device 100 to the second wireless communication device 200 may be expressed as a plurality of forward direction channel state information.

In addition, the plurality of channel state information H4, H5, H6 estimated by the plurality of digital waveforms S4, S5, S6 transmitted from the second wireless communication device 200 to the first wireless communication device 100 may be expressed as a plurality of reverse direction channel state information.

Here, the forward direction and backward direction notations are arbitrarily given to distinguish channel state information in each case.

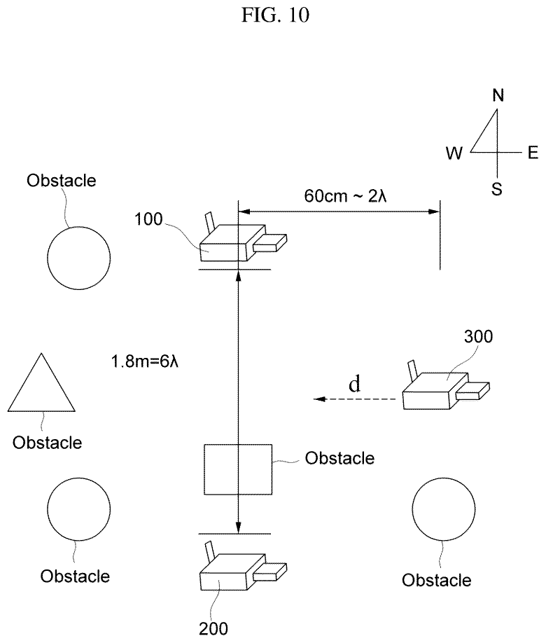

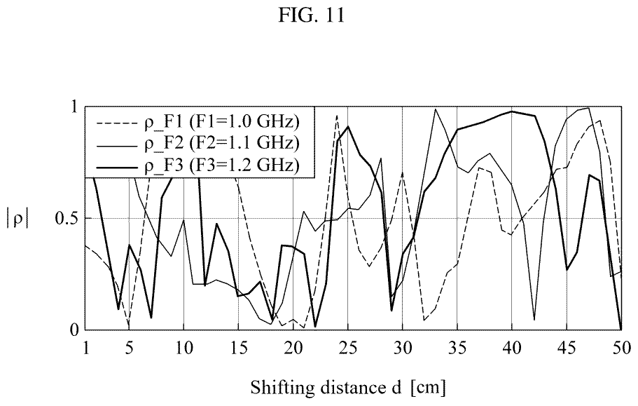

FIGS. 10 and 11 show a first experimental example for performance evaluation of the systems 1000 and 2000, which are the systems for multi-frequency band indoor channel state information-based physical layer authentication according to the present disclosure.

FIG. 10 is a diagram illustrating a state in which the systems 1000 and 2000, which are the systems for multi-frequency band indoor channel state information-based physical layer authentication according to the present disclosure, are implemented according to the first experimental example. FIG. 10 shows a first wireless communication device 100 and a second wireless communication device 200 and a plurality of obstacles where their position is fixed, and a third wireless communication device 300 where its position is changed.

Here, the second wireless communication device 200 is an authentication verifying node, the first wireless communication device 100 is a legitimate authentication requesting node registered in the second wireless communication device 200, and the third wireless communication device 300 is set as an illegitimate authentication requesting node not registered in the second wireless communication device 200.

In addition, the signals generated in the first wireless communication device 100 and the third wireless communication device 300 were set to a wavelength λ of about 30 cm, a bandwidth W of 18 MHz, and the number of subcarriers in multicarrier transmission N of 200.

In addition, the first center frequency F1, the second center frequency F2, and the third center frequency F3 were set in the first wireless communication device 100, the second wireless communication device 200, and the third wireless communication device 300, the first center frequency F1 was set to 1.0 GHz, the second center frequency F2 was set to 1.1 GHz, and the third center frequency F3 was set to 1.2 GHz.

In addition, the first wireless communication device 100 and the second wireless communication device 200 were disposed in the north and south direction S-N, and the distance between the first wireless communication device 100 and the second wireless communication device 200 was set to 1.8 m, which is about six times the signal wavelength λ generated in the first wireless communication device 100 and the third wireless communication device 300.

In addition, the third wireless communication device 300 was set to move in the east and west direction E-W while shifting within a distance d of 0 to 50 cm in the east side E from the coordinates of the east-west direction E-W of the first wireless communication device 100 and the second wireless communication device 200. Here, shifting distance d is set in less than 60 cm, which is about twice the signal wavelength λ generated in the first wireless communication device 100 and the third wireless communication device 300.

FIG. 11 shows a graph showing the results of the experiment example.

The dotted line graph ρ_F1 is calculated based on the first center frequency F1, the thin line graph ρ_F2 is calculated based on the second center frequency F2, and the thick line graph ρ_F3 is calculated based on the third center frequency F3.

Here, the horizontal axis of the graph is the shifting distance d that varies according to the movement of the third wireless communication device 300. In addition, the vertical axis of the graph is absolute value of the ratio ρ of channel state information H1, H2, H3 of a signal transmitted from the first wireless communication device 100 to the second wireless communication device 200 and channel state information H7, H8, H9 of a signal transmitted from the third wireless communication device 300 to the second wireless communication device 200. Here, the channel state information H1, H2, H3 of a signal transmitted from the first wireless communication device 100 to the second wireless communication device 200 are legitimate channel state information, and the channel state information H7, H8, H9 of a signal transmitted from the third wireless communication device 300 to the second wireless communication device 200 are illegitimate channel state information. Hereinafter, the corresponding absolute value of the ratio ρ is expressed as the correlation coefficient between the legitimate channel and the illegitimate channel.

The correlation coefficient between the legitimate and illegitimate channels is closer to 1 as the legitimate and illegitimate channel state information are similar, and closer to 0 as the legitimate and illegitimate channel state information are different.

Therefore, when the correlation coefficient between the legitimate channel and the illegitimate channel, that is, the coordinate of the vertical axis of the graph, is close to 1, a strong correlation between the first wireless communication device 100 and the third wireless communication device 100 may occur and the third wireless communication device 300 may be authenticated to be legitimate.

However, according to the present disclosure, the legitimacy determination module 243 of the second wireless communication device 200 determines that legitimacy of the third wireless communication device 300 has been authenticated when the plurality of channel state information H7, H8, H9 estimated through the signal received from the third wireless communication device 300 is all illegitimate.

However, in this experimental example, the vertical axis coordinates of the dotted line graph ρ_F1, the thin line graph ρ_F2, and the thick line graph ρ_F3 were not found to be close to 1 at the same time, and the probability of occurrence in this case is predicted to be very low.

That is, through the experimental examples of FIGS. 10 and 11, the effects of the present disclosure can be confirmed in that physical layer authentication is performed based on indoor channel state information of multiple frequency bands, thereby preventing false authentication due to a strong association between the legitimate authentication requesting node and the illegitimate authentication requesting node and improving the stability and reliability of security.

In addition, the present disclosure can be applied in both indoor and outdoor environments, but the effect can be maximized in indoors where the change width of a channel is monotonous compared to outdoors.

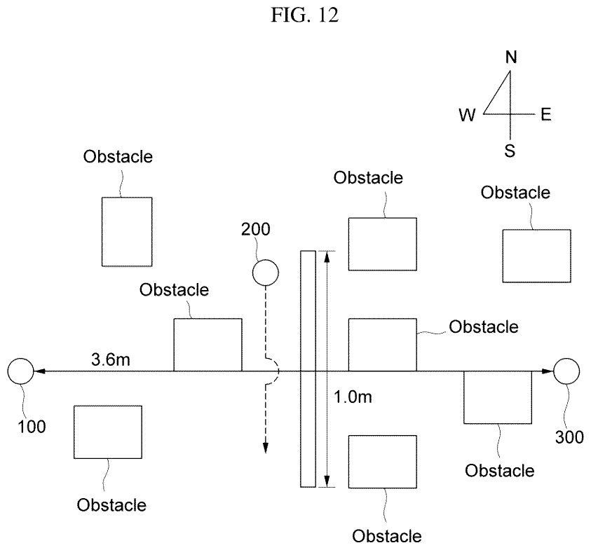

FIGS. 12 to 14 and Table 1 show a second experimental example for performance evaluation of the system 1000 and 2000, the system for multi-frequency band indoor channel state information-based physical layer authentication according to the present disclosure.

FIG. 12 is a diagram illustrating the systems 1000 and 2000, which are the systems for multi-frequency band indoor channel state information-based physical layer authentication according to the present disclosure, are implemented according to the first experimental example. FIG. 12 shows a first wireless communication device 100 where its position is changed, and a second wireless communication device 200 and a third wireless communication device 300 and a plurality of obstacles where their position is fixed.

Here, the second wireless communication device 200 is an authentication verifying node, the first wireless communication device 100 is a legitimate authentication requesting node registered in the second wireless communication device 200, and the third wireless communication device 300 is an illegitimate authentication requesting node not registered in the second wireless communication device 200.

In addition, the signals generated in the first wireless communication device 100 and the third wireless communication device 300 were set to the bandwidth W of 18 MHZ, and the number of subcarriers in multicarrier transmission N of 64.

In addition, in the first wireless communication device 100 and the second wireless communication device 200 and the third wireless communication device 300, two center frequencies among the first center frequency F1, the second center frequency F2, and the third center frequency F3 were set: F1 and F2, F2 and F3, F3 and F1. Here, the first center frequency F1 was set to 829 MHz, the second center frequency F2 was set to 847 MHZ, and the third center frequency F3 was set to 865 MHz.

Accordingly, the second wireless communication device 200 can estimate two legitimate channel state information through the signal received from the first wireless communication device 100, and two illegitimate channel state information through the signal received from the third wireless communication device 300, based on the corresponding two center frequencies: F1 and F2, F2 and F3, F3 and F1.

In addition, the second wireless communication device 200 was set to output the set of 50000 of the corresponding two legitimate channel state information through the legitimate data group forming module 222, and the set of 50000 of the corresponding two illegitimate channel state information through the illegitimate data group forming module 223.

In addition, the first wireless communication device 100 and the third wireless communication device 300 were arranged in the east-west direction E-W, and the distance between the first wireless communication device 100 and the third wireless communication device 300 was set to 3.6 m.

In addition, the second wireless communication device 200 was configured to move at a constant speed in the north-south direction N-S between the first wireless communication device 100 and the third wireless communication device 300. Here, the movement range of the second wireless communication device 200 was set to 1 m.

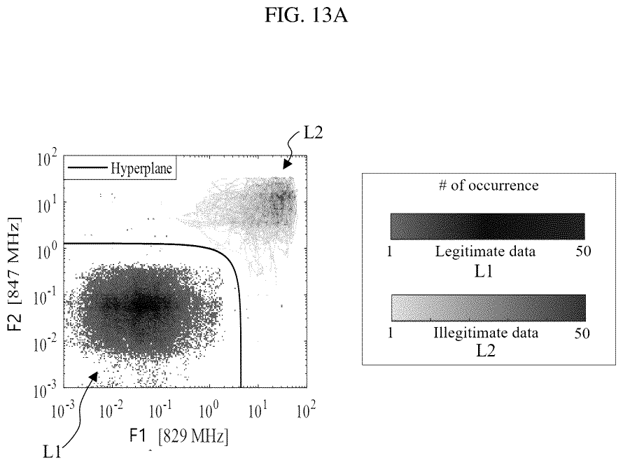

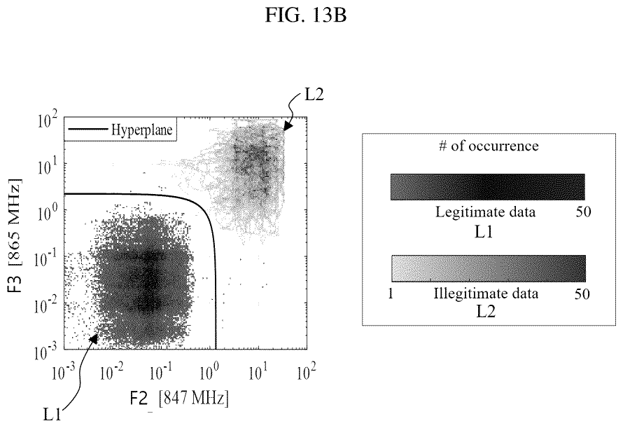

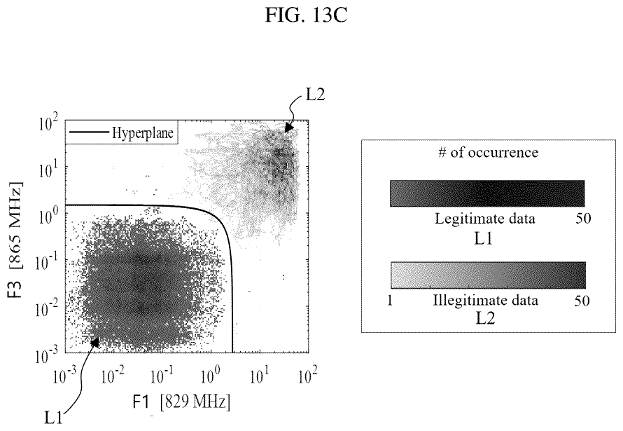

FIG. 13A shows the case that a hyperplane of the test statistics formed through the hyperplane forming module 224 when the first center frequency F1 and the second center frequency F2 are set in the first wireless communication device 100, the second wireless communication device 200, the third wireless communication device 300.

FIG. 13B shows the case that a hyperplane of the test statistics formed through the hyperplane forming module 224 when the second center frequency F2 and the third center frequency F3 are set in the first wireless communication device 100, the second wireless communication device 200, and the third wireless communication device 300.

FIG. 13C shows the case that a hyperplane of the test statistics formed through the hyperplane forming module 224 when the first center frequency F1 and the third center frequency F3 are set in the first wireless communication device 100, the second wireless communication device 200, and the third wireless communication device 300.

Referring to FIGS. 13A, 13B, and 13C, the legitimate data group L1 which is the test statistics of the legitimate channel state information and the illegitimate data group L2 which is the test statistics of the illegitimate channel state information are represented by dots. Here, the degree of integration of data is represented by the contrast.

As shown in FIGS. 13A, 13B, and 13C, the hyperplane of the test statistics can be provided as a means to clearly distinguish between the legitimate data group L1 and the illegitimate data group L2.

That is, the legitimacy determination module 243 of the second wireless communication device 200 may apply the test statistics output through the signal post-processing module 242 to the hyperplane of the test statistics output through the hyperplane forming module 224 to determine legitimacy or illegitimacy of the plurality of channel state information estimated through the signal received from the first wireless communication device 100, respectively.

In the second experimental example, a linear support vector machine classifier was used as the legitimacy determination module 243.

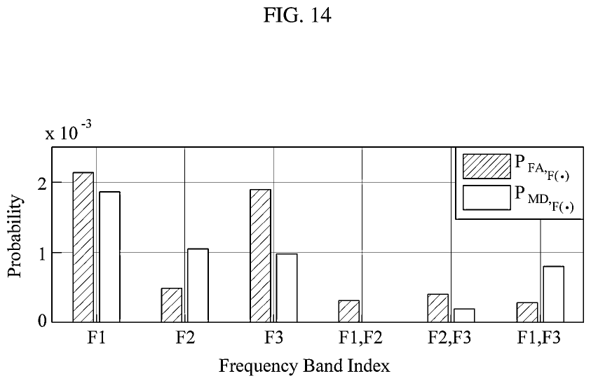

FIG. 14 is a diagram showing the probability of false alarm and missed detection of illegitimate authentication requesting nodes. Here, The probability of false alarm PFA of illegitimate authentication requesting nodes is shown by hatched bar, and the probability of missed detection PMD, that is, the probability of non-detection, of illegitimate authentication requesting nodes is shown by unshaded bar.

On the left side of FIG. 14, the probability of false alarm PFA and the probability of missed detection PMD of the illegitimate authentication requesting nodes measured in the physical layer authentication system for a single-frequency band according to the conventional technology, are shown. Here, in the first wireless communication device 100 and the second wireless communication device 200 and the third wireless communication device 300, only any one of the first center frequency F1 and the second center frequency F2 and the third center frequency F3 was set.

On the right side of FIG. 14, the probability of false alarm P_{FA} and the probability of missed detection P_{MD} of the illegitimate authentication requesting nodes measured in the physical layer authentication systems 1000 and 2000 for the multi-frequency bands, according to the embodiment shown in FIG. 12 and FIGS. 13A, 13B, 13C are shown. Here, in the systems 1000 and 2000, two center frequencies among the first center frequency F1 and the second center frequency F2 and the third center frequency F3 are set as modulation frequencies.

In addition, Table 1 shows the values of the probability of false alarm P_{FA} and the probability of missed detection P_{MD} of the illegitimate authentication requesting nodes, which is shown in FIG. 14. These values are measured in the physical layer authentication system for the single-frequency band and the multi-frequency bands respectively. And the unit of the values of the probability of false alarm PFA and the probability of missed detection P_{MD} in the Table 1 is 10⁻³.

TABLE 1

| Center frequency | F1 | F2 | F3 | F1, F2 | F2, F3 | F1, F3 |
|---|---|---|---|---|---|---|
| Probability of false | 2.14 | 0.48 | 1.90 | 0.32 | 0.40 | 0.28 |
| alarm P_{FA} of the | | | | | | |
| illegitimate authentica- | | | | | | |
| tion requesting nodes | | | | | | |
| Probability of missed | 1.86 | 1.04 | 0.98 | 0 | 0.20 | 0.80 |
| detection P_{MD} of the | | | | | | |
| illegitimate authentica- | | | | | | |
| tion requesting nodes | | | | | | |

Referring to FIGS. 14 and Table 1, it can be confirmed that the physical layer authentication processing system 1000 and 2000 for the multi-frequency band according to the present disclosure significantly decreases the probability of false alarm P_{FA} and the probability of missed detection P_{MD} of the illegitimate authentication requesting nodes, compared to the physical layer authentication system for the single-frequency band according to the conventional technology.

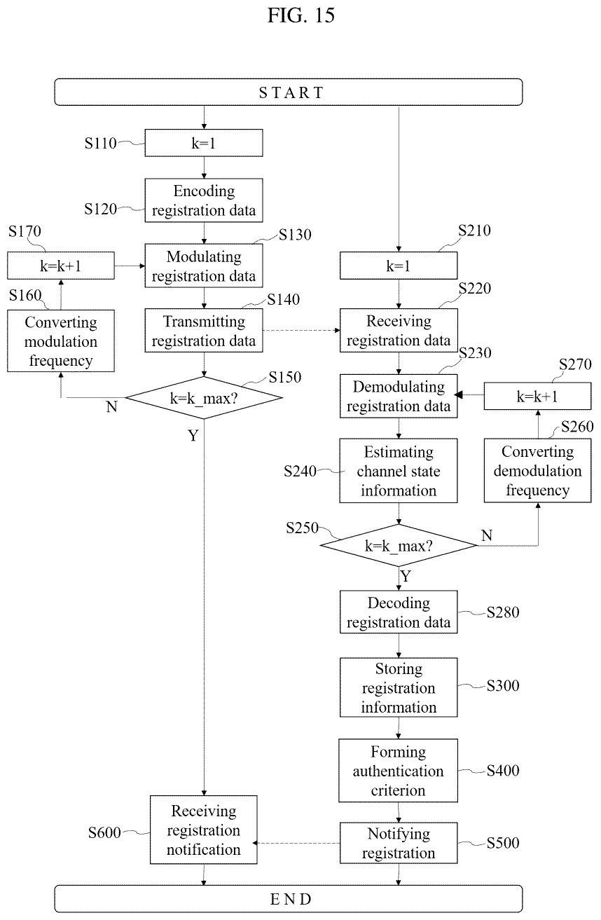

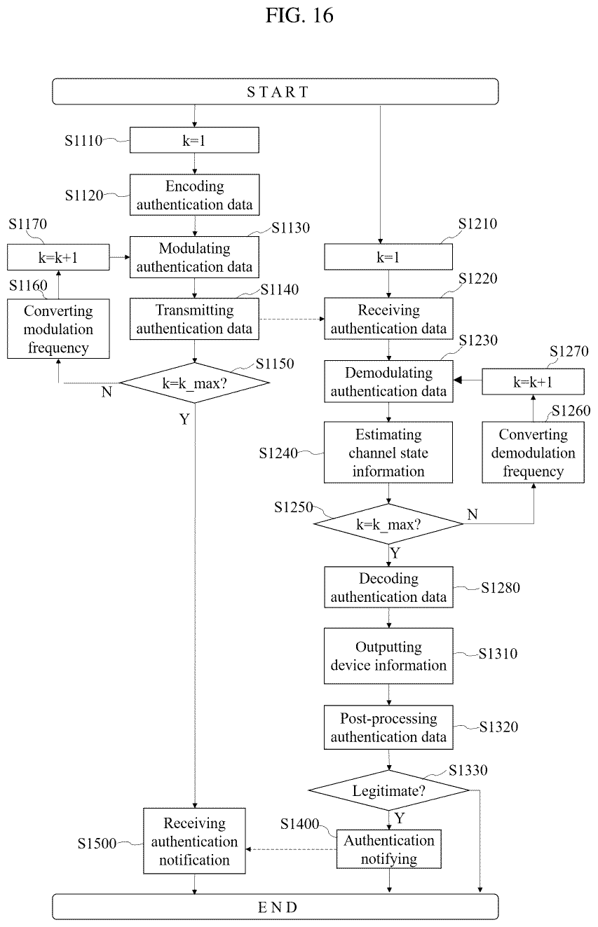

Hereinafter, with reference to FIGS. 15 to 16, a method for physical layer authentication according to the present disclosure will be described.

In FIG. 15, a flowchart illustrates a procedure for processing a device registration, which is included in the method for physical layer authentication according to the present disclosure.

According to the processing a device registration, given devices may be registered with the second wireless communication device 200 as a legitimate device, and a criterion for determining whether to authenticate may be set.

steps S110 to S170 are a procedure for requesting a registration, in which the first wireless communication device 100 sequentially modulates the device identification information and the pilot signal into a plurality of signals based on the plurality of center frequencies and transmits the plurality of signals.

Step S110 is a procedure for initializing, which sets a value of a variable k for checking the number of applied center frequencies to 1.

Step S120 is a procedure for encoding registration data, in which the device identification information and the pilot signal of the first wireless communication device 100 are converted into M-ary data symbols. Hereinafter, the registration data refers to data for device registration, including device identification information and pilot signals, and is comprised of various forms.

Step S130 is a procedure for modulating the registration data, in which the M-ary data symbols are sequentially modulated into a plurality of digital waveforms based on the modulation frequencies sequentially converted into the plurality of center frequencies.

Step S140 is a procedure for transmitting the registration data, in which the modulated plurality of digital waveforms are sequentially transmitted to the second wireless communication device 200.

Step S150 is a procedure in which the digital waveform is generated based on all the set center frequencies. Here, if the value of the variable k coincides with the number of the plurality of center frequencies set in the first wireless communication device 100 and the second wireless communication device 200, it is determined that the digital waveform is generated based on all the set center frequencies, and the digital waveform transmission to the second wireless communication device 200 is terminated. Referring to FIG. 15, the number of the plurality of center frequencies set in the first wireless communication device 100 and the second wireless communication device 200 is represented as k_max. In addition, if the value of the variable k does not coincide with the number of the plurality of center frequencies set in the first wireless communication device 100 and the second wireless communication device 200, which is represented as k_max, it is determined that the center frequency to generate the digital waveform remains, and the following step S160 is performed.

Step S160 is a procedure for converting a modulation frequency, in which the modulation frequency is sequentially converted into the plurality of center frequencies.

Step S170 is a procedure for correcting the value of variable k, in which 1 is added to the value of the variable k as the modulation frequency is converted into a new center frequency and the number of the applied center frequencies is increased by 1 in step S160.

Steps S210 to S280 are a procedure for accepting a registration request, in which the second wireless communication device 200 receives the plurality of digital waveforms transmitted from the first wireless communication device 100 and calculates the plurality of channel state information and the device identification number.

Step S210 is a procedure for initializing, in which the value of the variable k for checking the number of the applied center frequencies is set to 1.

Step S220 is a procedure for receiving the registration data, in which the plurality of digital waveforms transmitted from the first wireless communication device 100 through the transmitting the registration data is sequentially received.

Step S230 is a procedure for demodulating the registration data, in which the plurality of digital waveforms received through the receiving the registration data are sequentially demodulated into the plurality of M-ary data symbols, based on the demodulation frequency sequentially converted into the set plurality of center frequencies.

Step S240 is a procedure for estimating the channel state information, in which the plurality of channel state information are estimated from the plurality of digital waveforms received through the first wireless communication device 100 respectively based on the set plurality of center frequencies.

Here, the estimating the channel state information may be configured by estimating modified pilot signals from the demodulated plurality of M-ary data symbols to estimate the plurality of channel state information.

Step S250 is a procedure for checking whether channel state information is estimated based on all set center frequencies. Here, if the value of the variable k coincides with the number of a plurality of center frequencies set in the first wireless communication device 100 and the second wireless communication device 200, which is represented as k_max, it is determined that channel state information is estimated based on all set center frequencies, and the channel state information estimation is terminated. In addition, if the value of the variable k does not coincide with the number of a plurality of center frequencies set in the first wireless communication device 100 and the second wireless communication device 200, which is represented as k_max, it is determined that the center frequency to estimate the channel state information remains and the following step S260 is performed.

Step S260 is a procedure for converting a demodulation frequency, which sequentially converts a demodulation frequency into a plurality of set center frequencies.

Step S270 is a procedure for correcting the value of variable k, in which 1 is added to the value of the variable k as the demodulation frequency is converted into a new center frequency and the number of the applied center frequencies is increased by 1 in step S160.

Step S280 is a procedure for decoding the registration data, which converts the demodulated plurality of M-ary data symbols and outputs device identification information.

Step S300 is a procedure for storing registration information, in which the second wireless communication device 200 stores device identification information of the first wireless communication device 100 as registered device identification information and stores the estimated plurality of channel state information as a plurality of registered channel state information.

Step S400 is a procedure for forming an authentication criterion which sets a criterion for determining whether to authenticate the first wireless communication device 100.

The forming an authentication criterion may include forming a legitimate data group, forming a legitimate data group, and forming a hyperplane, which are not shown in the drawings.

The forming the legitimate data group is a procedure for collecting multiple sets of a plurality of channel state information transmitted from the first wireless communication device 100 to the second wireless communication device 200 based on a plurality of center frequencies and calculating the test statistics, respectively, to form the legitimate data group.

The forming the legitimate data group includes transmitting the authentication criterion, receiving the authentication criterion, and estimating the channel state information, which will be described later. And the forming the legitimate data group is a procedure for collecting the multiple sets of the plurality of channel state information based on the plurality of center frequencies, by repeatedly performing the transmitting the authentication criterion, the receiving the authentication criterion, and the estimating the channel state information.

Here, the number of the sets of a plurality of channel state information may be large enough to have a statistical meaning.

The transmitting the authentication criterion is a procedure for sequentially modulating the device identification information and the pilot signal to the plurality of digital waveforms based on the plurality of center frequencies at the first wireless communication device 100, and transmitting them to the second wireless communication device 200.

The receiving the authentication criterion is a procedure for receiving the plurality of digital waveforms transmitted from the first wireless communication device 100 at the second wireless communication device 200.

The estimating the channel state information is a procedure for estimating each of the plurality of channel state information from the plurality of digital waveforms received through the receiving the authentication criterion based on the plurality of center frequencies at the second wireless communication device 200.

The forming the illegitimate data group is a procedure for assuming multiple sets of a plurality of illegitimate channel state information based on the plurality of center frequencies and calculating test statistics for the illegitimate channel state information respectively to form an illegitimate data group;

The forming a hyperplane is a procedure for forming the hyperplane of at least one test statistic using the test statistics of the legitimate data group and the test statistics of the illegitimate data group based on the plurality of center frequencies.

Step 500 is a procedure for notifying a registration, in which the second wireless communication device 100 transmits a registration completion signal that the first wireless communication device 200 has been registered as legitimate to the first wireless communication device 100.

Step 600 is a procedure for receiving a registration notification, in which the first wireless communication device 100 receives the registration completion signal from the second wireless communication device 200.

In FIG. 16, a flowchart illustrates a procedure for processing a device authentication, which is included in the method for physical layer authentication according to the present disclosure.

Steps S1110 to S1170 are a procedure for requesting an authentication, in which the first wireless communication device 100 sequentially modulates the device identification information and the pilot signal for identifying the corresponding device into a plurality of signals based on the set plurality of center frequencies and transmits them to the second wireless communication device 200.

Here, step S1110 is a procedure for initializing, step S1120 is a procedure for encoding authentication data, step S1130 is a procedure for modulating the authentication data, step S1140 is a procedure for transmitting the authentication data, and step S1150 is a procedure for checking whether a digital waveform is generated based on all the center frequencies set. In addition, step S1160 is a procedure for converting a modulation frequency, and step S1170 is a procedure for correcting the value of variable k. Hereinafter, the authentication data refers to data for device authentication, including device identification information and pilot signals, and is comprised of various forms.

Steps S1110 to S1170 may be formed in the same configuration as those of Steps s110 to s170.

Steps S1210 to S1260 are a procedure for accepting an authentication request, in which the second wireless communication device 200 receives a plurality of digital waveforms transmitted from the first wireless communication device 100 through the requesting the authentication and calculates a plurality of channel state information and a device identification number.

Here, step S1220 is a procedure for receiving the authentication data, step S1230 is a procedure for demodulating the authentication data, step S1240 is a procedure for estimating the channel state information, and step S1250 is a procedure for checking whether channel state information is estimated based on all set center frequencies. In addition, step S1260 is a procedure for converting a demodulation frequency, step S1270 is a procedure for correcting the value of variable k, and step S1280 is a procedure for decoding the authentication data.

Steps S1220 to S1280 may be formed in the same configuration as those of Steps S220 to S280.

Steps S1310 to S1330 are a procedure for processing a physical layer authentication, which determines whether to authenticate the first wireless communication device 100 based on the estimated plurality of channel state information, at the second wireless communication device 200.

Step S1310 is a procedure for outputting device information, which outputs a plurality of registered channel state information by inputting the device identification information outputted through the accepting the authentication. Here, the plurality of registered channel state information corresponds to the device identification information outputted through the accepting an authentication request.

Step S1320 is a procedure for post-processing the authentication data, which calculates and outputs test statistics by inputting the plurality of channel state information estimated through estimating the channel state information and the plurality of registered channel state information outputted through the outputting the device information.

Step S1330 is a procedure for determining legitimacy, which determines and outputs whether the first wireless communication device 100 is authenticated by inputting the test statistics outputted through the post-processing the authentication data.

Here, the determining legitimacy includes determining whether the test statistics of the estimated plurality of channel state information are legitimate or illegitimate, by applying the test statistics of the channel state information calculated through the post-processing the authentication data to the hyperplane of the preset test statistics. And, the determining legitimacy includes determining that legitimacy of the first wireless communication device 100 is authenticated when all the plurality of channel state information estimated through the estimating the channel state information is determined to be legitimate.

Step S1400 is a procedure for notifying the authentication, which provides a notification that the second wireless communication device 100 has transmitted an authentication completion signal indicating that the first wireless communication device 200 is authenticated as legitimate to the first wireless communication device 100.

Step S1500 procedure for receiving an authentication notification, in which the first wireless communication device 100 receives the authentication completion signal from the second wireless communication device 200.

In addition, the first wireless communication device and the second wireless communication device may be both an authentication verifying node and an authentication requesting node.

In this case, the first wireless communication device takes the role of an authentication requesting node and the second wireless communication device takes the role of an authentication verifying node, as explained in the steps S110 to S500 and the steps S1110 to S1500. Here, the processing the device registration shown in FIG. 15 and the processing the device authentication shown in FIG. 16 may be referred to as a procedure for forward direction.

In addition, in this case, the first wireless communication device may take a role of an authentication verifying node and the second wireless communication device may take a role of an authentication requesting node. Here, the processing a device registration shown in FIG. 15 and the processing a device authentication shown in FIG. 16 may be performed in the same manner with the procedure for forward direction by setting the roles of the first wireless communication device 100 and the second wireless communication device 200 oppositely. And the steps shown in FIGS. 15 and 16 may be referred to as a procedure for reverse direction to distinguish from the procedure for forward direction.

In addition, according to the present disclosure, the processing the device registration and the processing the device authentication may be performed in series.

That is, given wireless communication devices may be registered in the second wireless communication device 200 by the processing the device registration and then authenticated by the processing the device authentication.

According to the present disclosure, in a system and a method for multi-frequency band indoor channel state information-based physical layer authentication, by improving the conventional technology to perform physical layer authentication based on multi-frequency band indoor channel state information, it is possible to prevent false authentication due to a strong association between channel state information of a legitimate authentication requesting node and channel state information of an illegitimate authentication requesting node in an indoor environment and to improve security stability and reliability.

The above description of the present disclosure is an example, and it will be understood by those skilled in the art that the present disclosure can easily be modified into other specific forms without changing the technical spirit or essential features of the present disclosure. Therefore, it should be understood that the above-described embodiments are exemplary in all aspects and are not limited. For example, each component described in a single form may be implemented and distributed, and components described as distributed may be implemented in a combination.

Therefore, the spirit of the present disclosure should not be limited to the above-described embodiments, and not only the claims of the present disclosure but also all modifications equivalent to the claims of the present disclosure fall within the scope of the spirit of the present disclosure.

### DETAILED DESCRIPTION OF MAIN ELEMENTS

1000: a unidirectional physical layer authentication system

2000: a bidirectional physical layer authentication system

100: first wireless communication device

200: second wireless communication device

300: third wireless communication device

What is claimed is:

1. A system for multi-frequency band indoor channel state information-based physical layer authentication, the system comprising:
a first wireless communication device that is an authentication requesting node and a second wireless communication device that is an authentication verifying node,
wherein the first wireless communication device comprises a transmitting unit that sequentially modulates device identification information and a given pilot signal for identifying the first wireless communication device into a plurality of signals based on a plurality of set center frequencies and transmits the plurality of signals, and
the second wireless communication device comprises:
a receiving unit that receives the plurality of signals transmitted from the first wireless communication device and estimates a plurality of channel state information based on the plurality of center frequencies respectively; and
a physical layer authentication processing unit that determines whether the first wireless communication device is authenticated based on the estimated plurality of channel state information.

2. The system of claim 1, wherein
the transmitting unit comprises:
a data encoding module that converts the device identification information and the pilot signal into M-ary data symbols;
a modulation frequency conversion module that sequentially converts a modulation frequency into the plurality of center frequencies;
a signal modulation module that sequentially modulates the M-ary data symbols into a plurality of digital waveforms based on the modulation frequency that is sequentially converted into the plurality of center frequencies; and
a transmitting module that sequentially transmits the plurality of digital waveforms, and
the receiving unit comprises:
a receiving module that sequentially receives the plurality of digital waveforms transmitted from the first wireless communication device;
a demodulation frequency conversion module that sequentially converts a demodulation frequency into the plurality of center frequencies;
a signal demodulation module that sequentially demodulates the plurality of digital waveforms received by the receiving module into a plurality of M-ary data symbols based on the demodulation frequency that is sequentially converted into the plurality of center frequencies;
a channel state information estimation module that estimates modified pilot signals from the demodulated plurality of M-ary data symbols and estimates the plurality of channel state information; and
a data decoding module that converts the demodulated plurality of M-ary data symbols and outputs the device identification information.

3. The system of claim 1, wherein
the physical layer authentication processing unit comprises:
a device information output module that outputs a plurality of registered channel state information by inputting the device identification information received by the receiving unit;
a signal post-processing module that calculates and outputs a test statistic by inputting the plurality of channel state information estimated by the receiving unit and the plurality of registered channel state information; and
a legitimacy determination module that determines whether the first wireless communication device is authenticated by inputting the test statistic.

4. The system of claim 3, wherein
the second wireless communication device further comprises a device registration processing unit that registers a given device as a legitimate device and sets a criterion for determining whether to authenticate, and
the device registration processing unit comprises:
a device registration module that stores the device identification information and the estimated plurality of channel state information received by the receiving unit as registered device identification information and a plurality of registered channel state information respectively;
a legitimate data group forming module that receives multiple sets of the plurality of signals transmitted from the first wireless communication device and calculates test statistics of the channel state information estimated from each signal to form a legitimate data group;
an illegitimate data group forming module that assumes multiple sets of a plurality of illegitimate channel state information based on the plurality of center frequencies and calculates the test statistics of the assumed illegitimate channel state information to form an illegitimate data group; and
a hyperplane forming module that forms a hyperplane of at least one test statistic using the test statistics of the legitimate data group and the test statistics of the illegitimate data group based on the plurality of center frequencies.

5. The system of claim 4, wherein
the test statistics are calculated as Euclidean distances of each channel state information.

6. The system of claim 4, wherein
the legitimacy determination module determines whether the test statistics of the estimated plurality of channel state information are legitimate or illegitimate by applying the test statistics of the estimated plurality of channel state information to the hyperplane formed by the hyperplane forming module, and determines that legitimacy of the first wireless communication device is authenticated when all the test statistics of the estimated plurality of channel state information are determined to be legitimate.

7. The system of claim 1, wherein
the second wireless communication device further comprises a transmitting unit that transmits an authentication confirmation signal to the first wireless communication device when the first wireless communication device is authenticated as legitimate.

8. The system of claim 1, wherein
the first wireless communication device and the second wireless communication device are both authentication verifying nodes and authentication requesting nodes,
the second wireless communication device further comprises a transmitting unit that sequentially modulates device identification information and the given pilot signal for identifying the second wireless communication device into a plurality of signals based on the plurality of center frequencies and transmits them to the first wireless communication device,
the estimated plurality of channel state information is a plurality of forward direction channel state information,
and the first wireless communication device comprises:
a receiving unit that receives a plurality of signals transmitted from the second wireless communication device and estimates a channel state information-a plurality of reverse direction channel state information—in which the plurality of signals from the second wireless communication device are transmitted, respectively; and
a physical layer authentication processing unit that determines whether to authenticate the second wireless communication device based on the plurality of reverse direction channel state information.

9. A method for multi-frequency band indoor channel state information-based physical layer authentication, the method comprising:
requesting an authentication, which sequentially modulates device identification information and a given pilot signal for identifying a first wireless communication device into a plurality of signals based on a plurality of set center frequencies and transmits the plurality of signals, at the first wireless communication device;
accepting an authentication request, which receives the plurality of signals transmitted from the first wireless communication device by the requesting the authentication, estimates a plurality of channel state information and calculates the device identification information, in a second wireless communication device; and
processing a physical layer authentication, which determines whether the first wireless communication device is authenticated based on the estimated plurality of channel state information, at the second wireless communication device,
wherein the accepting the authentication request comprises estimating the channel state information, which estimates the plurality of channel state information from the plurality of signals received by the accepting the authentication request based on the plurality of center frequencies.

10. The method of claim 9, wherein
the requesting the authentication comprises:
encoding authentication data, which converts the device identification information and the pilot signal into M-ary data symbols;
converting a modulation frequency which sequentially converts the modulation frequency into the plurality of center frequencies;
modulating the authentication data, which sequentially modulates the M-ary data symbol to a plurality of digital waveforms based on the modulation frequency sequentially converted into the plurality of center frequencies; and
transmitting the authentication data, which sequentially transmits the plurality of digital waveforms,
wherein the accepting the authentication request comprises:
receiving the authentication data, which sequentially receives the plurality of digital waveforms of the first wireless communication device transmitted by the transmitting the authentication data;
converting a demodulation frequency, which sequentially converts the demodulation frequency into the plurality of center frequencies;
demodulating the authentication data, which sequentially demodulates the plurality of digital waveforms received by the receiving the authentication data to a plurality of M-ary data symbols based on the demodulation frequency sequentially converted into the plurality of center frequencies; and
decoding the authentication data, which converts the demodulated plurality of M-ary data symbols and outputs the device identification information,
wherein in the estimating the channel state information, the plurality of channel state information is estimated by estimating modified pilot signals from the demodulated plurality of M-ary data symbols respectively.

11. The method of claim 9, wherein
the processing the physical layer authentication comprises:
outputting device information, which outputs a plurality of registered channel state information by inputting the device identification information outputted by the accepting the authentication;
post-processing the authentication data, which calculates and outputs a test statistic by inputting the estimated plurality of channel state information and the plurality of registered channel state information; and
determining legitimacy, which determines whether the first wireless communication device is authenticated by inputting the test statistic.

12. The method of claim 11, further comprising
processing a device registration, which registers a given device as a legitimate device, and sets a criterion for determining whether to authenticate, at the second wireless communication device,
wherein the processing a device registration comprises:
requesting a registration, which sequentially modulates the device identification information and the pilot signal to the plurality of signals based on the plurality of center frequencies, and transmits the plurality of signals, at the first wireless communication device;
accepting a registration request, which receives the plurality of signals transmitted from the first wireless communication device by the requesting the registration, estimates the plurality of channel state information, and calculates device identification information, at the second wireless communication device; and
storing registration information, which stores the device identification information of the first wireless communication device as registered device identification information and stores the estimated plurality of channel state information as the plurality of registered channel state information, at the second wireless communication device,
wherein the accepting the registration request comprises estimating the channel state information, which estimates the plurality of channel state information from the plurality of signals received by the accepting the registration request based on the plurality of center frequencies, respectively.

13. The method of claim 12, wherein
the requesting the registration comprises:
encoding registration data, which converts the device identification information and the pilot signal into M-ary data symbols;
converting a modulation frequency, which sequentially converts the modulation frequency into the plurality of center frequencies;
modulating the registration data, which sequentially modulates the M-ary data symbols to a plurality of digital waveforms based on the modulation frequency sequentially converted into the plurality of center frequencies; and
transmitting the registration data, which sequentially transmits the plurality of digital waveforms,
wherein the accepting the registration request comprises:
receiving the registration data, which sequentially receives the plurality of digital waveforms of the first wireless communication device transmitted by the transmitting the registration data;
converting a demodulation frequency, which sequentially converts the demodulation frequency into the plurality of center frequencies;
demodulating the registration data, which sequentially demodulates the plurality of digital waveforms received by the receiving the registration data to a plurality of M-ary data symbols based on the demodulation frequency sequentially converted into the plurality of center frequencies; and
decoding the registration data, which converts the demodulated plurality of M-ary data symbols, and outputs the device identification information,
wherein in the estimating the channel state information in the accepting a registration request, the plurality of channel state information is estimated by estimating modified pilot signals from the demodulated plurality of M-ary data symbols, respectively.

14. The method of claim 12, wherein
the processing a device registration comprises forming an authentication criterion which sets the criterion for determining whether to authenticate the first wireless communication device,
wherein the forming the authentication criterion comprises:
forming a legitimate data group, which collects multiple sets of the plurality of channel state information transmitted from the first wireless communication device to the second wireless communication device based on the plurality of center frequencies, and calculates test statistics respectively to form the legitimate data group;
forming an illegitimate data group, which assumes multiple sets of a plurality of illegitimate channel state information based on the plurality of center frequencies and calculates the test statistics of the assumed illegitimate channel state information to form the illegitimate data group; and
forming a hyperplane, which forms a hyperplane of at least one test statistic using the test statistics of the legitimate data group and the test statistics of the illegitimate data group based on the plurality of center frequencies.

15. The method of claim 14, wherein
the forming the legitimate data group comprises:
transmitting the authentication criterion, which modulates the device identification information and the pilot signal sequentially to the plurality of signals based on the plurality of center frequencies, and transmits the plurality of signals, at the first wireless communication device;
receiving the authentication criterion, which receives the plurality of signals transmitted from the first wireless communication device by the transmitting the authentication criterion, at the second wireless communication device; and
estimating the channel state information which estimates the plurality of channel state information from the plurality of signals received by the receiving the authentication criterion based on the plurality of center frequencies, at the second wireless communication device,
wherein the multiple sets of the plurality of channel state information are collected by repeatedly performing the transmitting the authentication criterion, the receiving the authentication criterion, and the estimating the channel state information in the forming the legitimate data group.

16. The method of claim 14, wherein
the test statistics are calculated as Euclidean distances of each channel state information.

17. The method of claim 14, wherein
in the determining legitimacy,
legitimacy or illegitimacy is determined by applying the test statistics of the channel state information calculated by the post-processing the authentication data to the hyperplane of the test statistics, and
authentication of legitimacy of the first wireless communication device is determined when all the test statistics of the estimated plurality of channel state information are determined to be legitimate.

18. The method of claim 9, wherein
the first wireless communication device and the second wireless communication device are both authentication verifying nodes and authentication requesting nodes,
the estimated plurality of channel state information is a plurality of forward direction channel state information,
the requesting the authentication is requesting a forward direction authentication,
the accepting the authentication request is accepting a forward direction authentication request,
the estimating the channel state information is estimating forward direction channel state information,
the processing the physical layer authentication is processing a forward direction physical layer authentication, and
the method comprises:
requesting a reverse direction authentication, which sequentially modulates the device identification information and the given pilot signal for identifying the second wireless device to a plurality of signals based on the plurality of center frequencies, at the second wireless communication device;
accepting a reverse direction authentication request, which receives the plurality of signals transmitted from the second wireless communication device by the accepting a reverse direction authentication request, at the first wireless communication device;
estimating reverse direction channel state information, which estimates a plurality of reverse direction channel state information from the plurality of signals received by the accepting a reverse direction authentication request based on the plurality of center frequencies, at the first wireless communication device; and
processing a reverse direction physical layer authentication, which determines whether the second wireless communication device is authenticated based on the estimated plurality of reverse direction channel state information, at the second wireless communication device.

19. The method of claim 9, further comprising
notifying the authentication, which transmits an authentication completion signal to the first wireless communication device when the first wireless communication device is authenticated as legitimate, at the second wireless communication device.
